(19) United States
(12) Patent Application Publication
(10) Pub. No.: US 2026/0221696 A1
(43) Pub. Date: Jul. 30, 2026

(54) CONNECTOR SHIELD WITH OPENINGS FOR ENHANCED SIGNAL INTEGRITY AND SIMPLIFIED ASSEMBLY

(71) Applicant: Amphenol East Asia Limited ( Hong Kong), Kowloon (HK)

(72) Inventors: Lo-Wen Lu, Taoyuan City (TW); Hsiu-Chi Liu, Taoyuan City (TW)

(73) Assignee: Amphenol East Asia Limited (Hong Kong), Kowloon (HK)

(21) Appl. No.: 19/458,655

(22) Filed: Jan. 23, 2026

(30) Foreign Application Priority Data
Jan. 24, 2025 (TW) 114201111
Jan. 24, 2025 (TW) 114201112

(51) Int. Cl. H01R 13/6585; H01R 12/72; H01R 13/04; H01R 13/504; H01R 13/516; H01R 13/6461; H01R 13/652; H01R 13/6597

(52) U.S. Cl. CPC H01R 13/6585; H01R 12/72; H01R 13/04; H01R 13/5045; H01R 13/516; H01R 13/6461; H01R 13/652; H01R 13/6597

(57) ABSTRACT

A connector with a shield with openings to facilitate economic yet stable assembly of the connector with effective shielding. Terminals in the connector may be integrated into one or more terminal sets, with a row of terminals held by an insulative housing. The housing includes projections shaped to attach the terminal set to another connector component, such as a support member that engages terminal sets on two sides. The projections may extend from the housing, through openings in the shield and lock in channels in the support member. The projections may have wider portions that are more distal than narrower portions, and the channels may have a complimentary shape so as to lock the housing to the other connector component, capturing the shield between those components.

### CROSS-REFERENCE TO RELATED APPLICATIONS

This application claims priority Taiwanese Patent Application No. 114201112, filed on Jan. 24, 2025 and Taiwanese Patent Application No. 114201111, filed on Jan. 24, 2025.

The contents of these applications are incorporated herein by reference in their entirety.

### TECHNICAL FIELD

The present application relates to a connector, and in particular to a separable connector for passing high-speed signals between electronic assemblies.

### BACKGROUND

A connector is a key component commonly used in electronic devices and systems. A main function of a connector is to establish a stable electrical connection and transmit power and data signals. Therefore, connectors have been widely used in various applications, including consumer electronic devices (such as mobile phones and tablet computers), communication equipment, industrial automation devices, and vehicle electronic systems, etc.

With the continuous advancement of technology and the diversification of application requirements, the structure and the performance of connectors have also evolved. For example, for high-speed signal transmission applications, connectors need to have excellent signal integrity and low loss characteristics; for industrial environments with high reliability requirements, it is necessary to emphasize their durability, vibration resistance and environmental protection characteristics, for example, waterproofing, dustproofing and high temperature resistance, etc.

Connectors may have a configuration that complies with a standard to facilitate connection of components made by different entities. An example of a standard is PCIe. Such standards may be updated over time to reflect increasing performance desired for connectors as electronic products are designed for higher performance, such as faster operation, or to provide greater functionality.

Some connectors are manufactured with terminal sets formed as subassemblies. Each terminal set may include a row of contacts, which may include signal contacts interspersed with ground contacts. These contacts may be held together with a terminal set housing. The contacts may be stamped from a sheet of metal, such that all of the contacts have broadsides aligned in a plane, with edges of adjacent contacts facing each other.

Further, with the increasing complexity of the electromagnetic environment, connectors with shielding have been designed to effectively reduce electromagnetic interference (EMI) and ensure signal stability.

Satisfying multiple requirements, sometimes conflicting, in a connector such as signal stability, mechanical robustness and reduced size, may be difficult.

### SUMMARY

Techniques as disclosed herein may be embodied as a shield for an electrical connector. The shield may comprising an elongated metal strip bent to form a plurality of projections. The metal strip may comprise a plurality of openings, therethrough, and the openings may be aligned with the projections.

Optionally, the metal strip may be elongated in a first direction; and the shield may comprise a plurality of elastic arms each aligned with an opening of the plurality of openings along a second direction orthogonal to the first direction.

Optionally, the shield may be used with a terminal set comprising a row of terminals and an insulative housing holding the terminals. The insulative housing may comprise a plurality of projections extending through respective openings of the plurality of openings.

Optionally, the row of terminals may comprise signal terminals and ground terminals; and the plurality of openings are aligned with respective ground terminals in the terminal set.

Optionally, an area of the metal strip between two adjacent openings may be aligned with a gap between two adjacent signal terminals.

Optionally, the insulative housing may comprises a plurality of recesses; and the plurality of projections of the elongated metal strip extend into respective recesses in the insulative housing.

In another aspect, techniques as described herein may be embodied as a terminal assembly for an electrical connector. The terminal assembly may comprise a terminal set comprising a plurality of signal terminals; a plurality of ground terminals; and a terminal set housing holding the plurality of signal terminals and the plurality of ground terminals. The terminal assembly may also comprise a metal shield which is assembled to a side of the terminal set housing and comprises a plurality of openings. The side of the terminal set housing comprises a plurality of protrusions, at least one of the plurality of protrusions aligned with a ground terminal of the plurality of ground terminals; and the at least one of the plurality of protrusions extends through at least one of the plurality of openings.

Optionally, at least two signal terminals of the plurality of signal terminals are adjacent to each other, and an area of the metal shield between two adjacent openings is aligned with a gap between the two adjacent signal terminals.

Optionally, the side of the terminal set housing may be provided with a plurality of recesses, each of the plurality of recesses may be aligned with a respective ground terminal of the plurality of ground terminals; the metal shield comprises a plurality of projections; each of the plurality of projections of the metal shield extends into a respective recess of the plurality of recesses; and openings of the plurality of openings extend through the metal shield at respective projections of the plurality of projections.

Optionally, the metal shield may be elongated in a first direction; the metal shield comprises a plurality of elastic arms, and each of the plurality of elastic arms is aligned with the plurality of openings along a second direction, orthogonal to the first direction.

Optionally, the metal shield may comprise at least one aperture aligned with a ground terminal of the plurality of ground terminals; and the metal terminal is configured such that liquid solder is injected through the aperture, once the liquid solder hardens, the hardened solder, the metal shield and the ground terminal are electrically connected.

Optionally, terminal assembly may be combined with an insulating body comprising a slot. The plurality of signal terminals and the plurality of ground terminals may comprise contact sections; and the terminal assembly may be disposed within the insulating body such that the contact sections of the plurality of signal terminals and the plurality of ground terminals are exposed in the slot so as to provide a docking port.

In another aspect, techniques as described herein may be embodied as a connector. The connector may comprise a terminal assembly comprising: a terminal set. The terminal set may comprise a plurality of metal terminals; and a terminal set housing attached to the plurality of metal terminals, with a side of the terminal set housing comprising with a plurality of projections, each of which has a cross-sectional shape with varying dimensions. The connector may comprise a support member, comprising a first side with a plurality of channels therein. The plurality of projections may extend into respective channels of the plurality of channels; and the cross-sectional shape of each of the plurality of channels may match the cross-sectional shape each of the projections, such that each of the channels and each of the projections mutually engage and interlock, whereby the terminal set housing is attached to the support member.

Optionally, the plurality of projections may each be configured as a wedge, and the plurality of channels is each configured as a groove with tapered sides.

Optionally, the terminal assembly further comprises a metal shield comprising a plurality of openings; and the plurality of projections of the terminal set housing may pass through respective ones of the plurality of openings such that the metal shield is captured between the terminal set housing and the support member.

Optionally, the terminal set is a first terminal set and the plurality of channels are a first plurality of channels; the terminal assembly may comprise a second terminal set comprising a terminal set housing with a plurality of projections; the support member comprises a second side with a second plurality of channels therein; and the plurality of projections of the terminal set housing of the second terminal set extend into and interlock with respective channels of the second plurality of channels.

Optionally, the terminal set housing of the first terminal set may comprise at least one first limiting block aligned with a channel of the second plurality of channels; and the terminal set housing of the second terminal set comprises at least one second limiting block aligned with a channel of the first plurality of channels.

Optionally, the first limiting block buts against a projection of the terminal set housing of the second terminal set; and the second limiting block buts against a projection of the terminal set housing of the first terminal set.

Optionally, the terminal assembly may further comprise a first metal shield and a second metal shield, wherein the first metal shield is assembled between the first terminal set housing and the support member, and the second metal shield is assembled between the second terminal set housing and the support member; the first metal shield may comprise a plurality of openings and a projection of the plurality of projections of the first terminal set housing or the first limiting block passes therethrough; and the second metal shield may comprise a plurality of openings and a projection of the plurality of projections of the second terminal set housing or the second limiting block passes therethrough.

Optionally, the connector may comprise an insulating body, and the terminal assembly may be disposed within the insulating body.

To further illustrate the objects, technical features, and functions of the present application, specific embodiments are described in detail below with reference to the accompanying drawings. However, the drawings are provided solely for reference and illustration and are not intended to limit the scope of the present application.

### BRIEF DESCRIPTION OF THE DRAWINGS

FIG. 1A is a perspective, lower front view of a connector set with two connectors in an unmated state, according to some embodiments described herein.

FIG. 1B is a perspective upper front view of the connector set of FIG. 1A in the unmated state.

FIG. 1C is a perspective view of the connector set of FIG. 1A in a mated state.

FIG. 1D is a cross-sectional view of the connector set of FIG. 1C.

FIG. 2 is an exploded view of a receptacle connector in the connector set of FIG. 1A.

FIG. 3A is an exploded view of two receptacle terminal sets and a support member of the connector of FIG. 2.

FIG. 3B is an exploded schematic view of two receptacle terminal sets and a support member of FIG. 3A.

FIG. 4A is a side view of a receptacle signal terminal of the connector of FIG. 2.

FIG. 4B is a side view of a receptacle ground terminal of the connector of FIG. 2.

FIG. 5A is a perspective view of receptacle signal terminals and the receptacle ground terminals in a repeating G-S-S pattern in the connector of FIG. 2.

FIG. 5B is a front view of the arrangement of the receptacle signal terminals and the receptacle ground terminals of FIG. 5A.

FIG. 6 is a cross-sectional view of a receptacle connector of FIG. 2, taken through signal terminals.

FIG. 7 is an enlarged view of a portion of the cross-section of FIG. 6.

FIG. 8 is a partial cross-sectional view of a receptacle insulating body of the connector of FIG. 2.

FIG. 9 is plot of simulation results of the Far-End Crosstalk of the receptacle connector of FIG. 2.

FIG. 10A is an exploded perspective view of a terminal set and a metal shield of the connector of FIG. 2.

FIG. 10B is a view of the terminal set and metal shield of FIG. 10A in an assembled state.

FIG. 11A is an exploded perspective view of a terminal set and a support member of the connector of FIG. 2.

FIG. 11B is a top view of the terminal set and support member of FIG. 11A in an assembled state.

FIG. 12A is an exploded perspective view of an alternative exemplary embodiment of a terminal set and support member, according to some embodiments described herein.

FIG. 12B is a perspective view of the terminal set and support member of FIG. 12A in an assembled state.

FIG. 12C is a top view of the terminal set and support member of FIG. 12A.

FIG. 12D is a top view of the terminal set and a support member of FIG. 12A assembled with a second, like terminal set.

FIG. 12E is a perspective view of a portion of the terminal sets of FIG. 12D, with the terminals of one terminal set and the support member omitted.

FIG. 13 is an exploded perspective view of a plug connector of FIG. 1A.

FIG. 14 is a cross-sectional view of a docking portion of the plug connector of FIG, 13.

FIG. 15 is a front plan view of the docking portion, according to some embodiments described herein.

### DETAILED DESCRIPTION

The inventors have recognized and appreciated techniques to reduce crosstalk that may be cost effectively incorporated into a connector yet provide for stable signal propagation through the connector. These techniques may include a metal shield for a terminal set and techniques for holding the metals shield to the terminal set such that there is a stable spacing between the metal shield and the terminals of the terminal set.

Further, the shield may have openings therethrough, which may be positioned with respect to ground terminals to reduce crosstalk and/or to enable projections from a terminal set housing and/or another connector component to pass through the shield. The projections may hold the terminal set and the other connector component together, with the shield captured therebetween. The projections and complementary channels may be shaped to hold the terminal set and the other connector component in a stable relationship such that the shield is stably held with respect to the terminal.

The terminal set may have a row of terminals held in a terminal set housing. Some of the terminals may be designated as signal terminals and others may be designated as ground terminals. The designated signal terminals may be disposed in pairs along the row, bounded by adjacent ground terminals, for example. In some examples, openings in the shield may be aligned with the ground terminals.

In some examples the shield may be wavy or corrugated. For example, the shield may be formed from a sheet of metal extending in a row direction. Portions of the shield may be bent out of the plane of the metal sheet, forming protrusions, which may be used for making mechanical and/or electrical connections to ground terminals in the terminal set. The terminal set housing, for example, may have recesses exposing the ground terminals and the protruding portions of the shield may extend into these recesses.

In some examples, the shield may include openings in these protruding portions of the shield. The protrusions of the terminal set housing or other component of the connector may extend through these openings. In some examples, the protrusions may be shaped to facilitate engagement of the terminal set housing and other component. The protrusions for example may have tapered sides. The tapered sides may make the protrusions wedge-shaped and may facilitate engagement in locations where such engagement may press the shields and terminal set together so as to make a stable connection between the shield and ground terminals.

Alternatively or additionally, the shield may include openings aligned with ground terminals even if no protrusion passes through the opening. Such openings may not substantially reduce crosstalk reduction, such as may occur from a shield without openings.

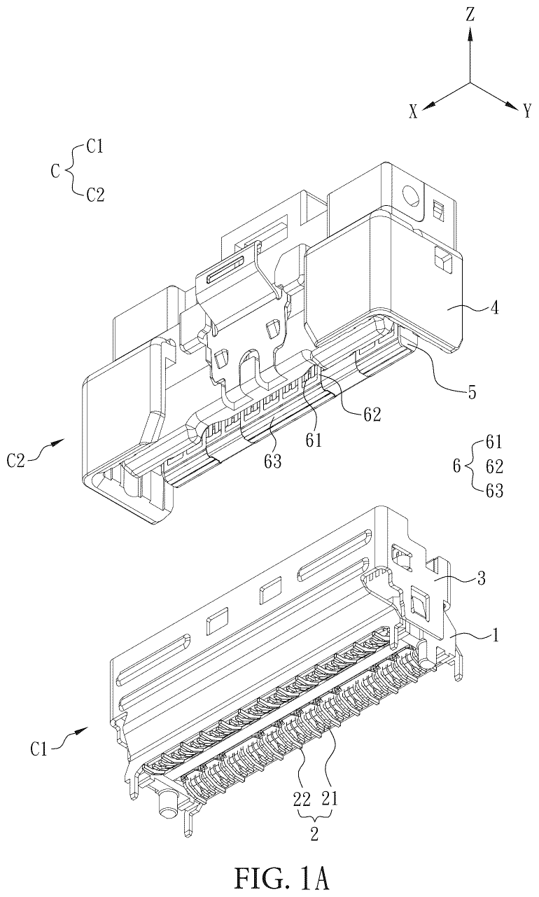

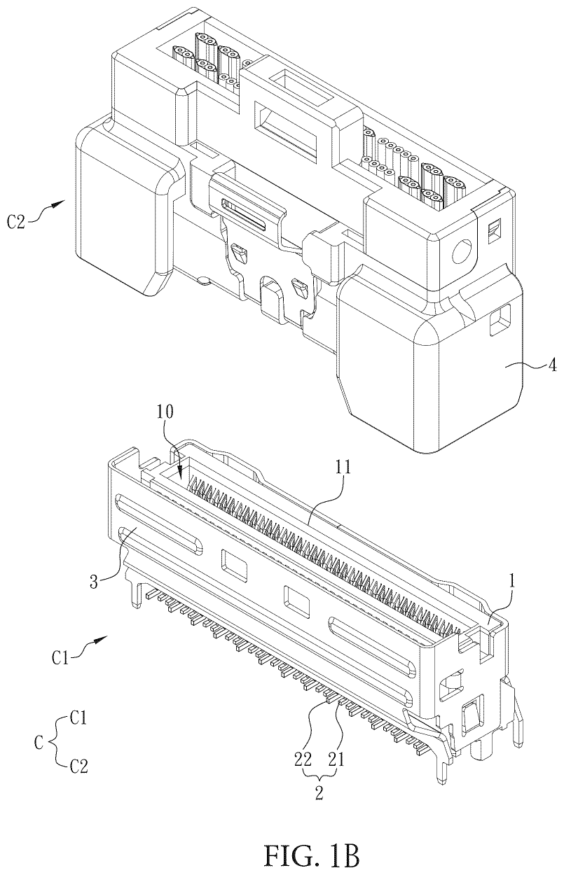

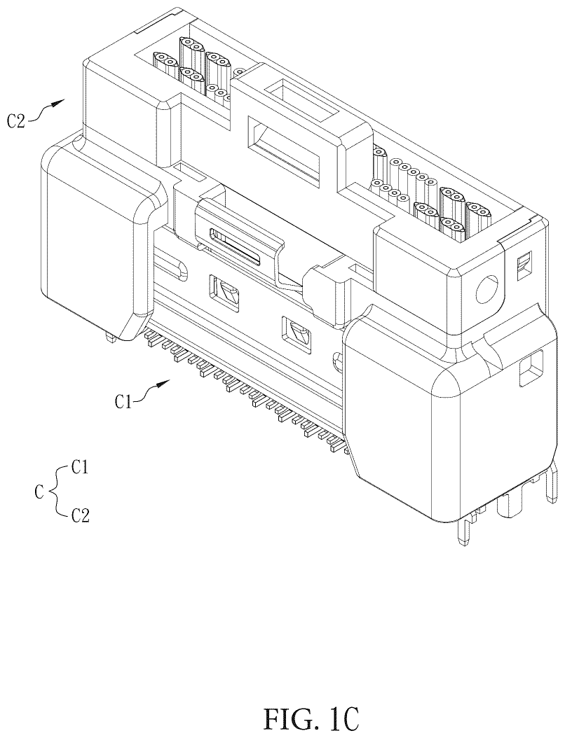

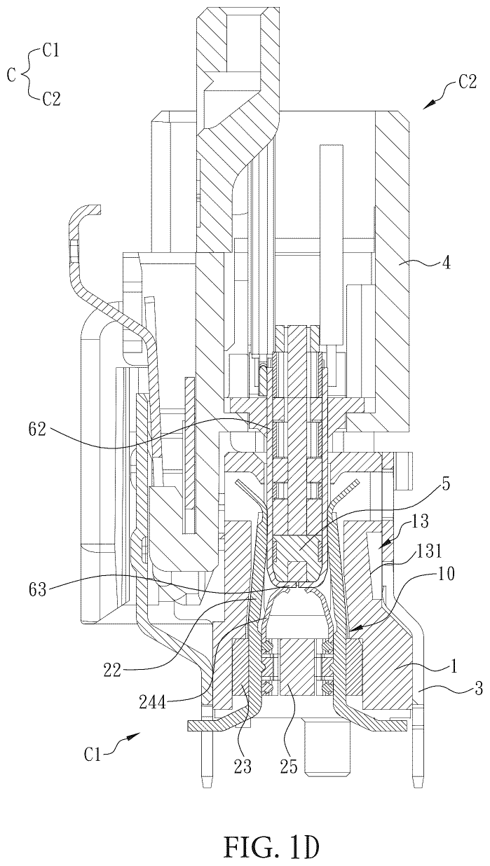

Here, the basic architecture of the connector set C is introduced first. Please refer to FIGS. 1A to 1D. The connector set C includes a receptacle connector C1 and a plug connector C2 that can be plugged together, wherein the receptacle connector C1 can be connected to a transmission carrier (such as a pad or a hole in a printed circuit board, a conductor of a cable or other substrate) and the plug connector C2 may be connected to another transmission carrier. When the receptacle connector C1 and the plug connector C2 are plugged together, power and/or signal transmission can be achieved between the two transmission carriers. Furthermore, based on the diversity of product requirements, the types of the two transmission carriers may be the same or different. For example, they may be circuit boards or transmission lines.

Techniques as described herein may apply to connectors coupled to any of multiple types of transmission carriers. In the example of FIG. 1A, connector C1 is configured for mounting to a printed circuit board as the signal and ground fixing sections of the terminals in connector C1 are shaped for surface mount soldering to conductive pads on a surface of a printed circuit board. In that example, connector C2 is configured for terminating cables, which are shown cutaway for example in FIG. 1B. In this example, the cables at each end of the connector are dual drain twinax cables and the cables in the central portion of the connector are single conductor cables. Twinax cables may carry high frequency signals, while single conductor cables may carry low frequency signals, such as control signals, power or ground.

A connector such as C2 may have highspeed sections at each end and a low-speed section in the middle. In the high speed section, the terminals may be grouped with a pair of signal terminals adjacent to each other in the row of terminals bordered by ground terminals. The signal terminals, for example, may be terminated to the signal conductors of a twinax cable, and the ground terminals may be terminated to drain wires or a cable shield. Such a configuration results in a repeating pattern of Ground-Signal-Signal (G-S-S) terminals in the high speed section, as illustrated herein. In other examples, other repeating patterns may be used in the high-speed sections, such as G-S-S-G. In some examples, the connectors may be configured with high speed and low speed sections according to a standard, such as PCIe Gen 6 or Gen 7.

A mating connector, such as C2, configured for mounting to a substrate may have corresponding high speed and low speed sections. Regardless of how a connector is configured, fixing sections of the terminals in the high speed sections may have ground fixing sections and signal fixing sections configured differently from each other, as described herein to reduce crosstalk. In some examples, the fixing sections in the low speed sections may be similar to those in the high speed sections, with fixing sections of grounded terminals shaped and/or oriented differently than fixing sections of other terminals in the low speed section.

Techniques as described herein may improve electromagnetic performance of a connector (such as reduced electromagnetic interference (EMI), increased electromagnetic compatibility (EMC) and/or reduce crosstalk) to ensure reliable connection and signal integrity of a connector set. In connection with the example shown in FIGS. 1A to 1D, the structural components and technical features in the receptacle connector C1 or the plug connector C2 will be described in detail below to illustrate the relevant structural features for achieving the electromagnetic performance optimization of the present application. Furthermore, it is hereby clarified that the structural features of some assemblies may be applied to the receptacle connector C1 and/or the plug connector C2 according to actual needs, and are not limited to the forms of subsequent embodiments.

To facilitate the description of component features and their relative position relationships as appearing the drawings, in the subsequent description, the spatial configuration of the components is defined based on three mutually orthogonal axes. The aforementioned three axes are the horizontal axis (X-axis), the longitudinal axis (Y-axis) and the vertical axis (Z-axis). A plane defined by the X and Y axes may correspond to a plane of a substrate to which a board connector (e.g. C1) is mounted, and Z may refer to a direction orthogonal to that plane in a direction from which a mating connector (e.g. C2) is pressed to mate with the board connector.

In the examples presented herein, the horizontal axis (X-axis) refers to the left-right extension direction, wherein the lower left of FIG. 1A corresponds to the left side of the assembly, and the upper right of FIG. 1A corresponds to the right side of the assembly; the longitudinal axis (Y-axis) refers to the front-back extension direction, wherein the upper left of FIG. 1A corresponds to the front side of the assembly, and the lower right of FIG. 1A corresponds to the rear side of the assembly; the vertical axis (Z-axis) refers to the up-down extension direction, wherein the upper part of FIG. 1A corresponds to the upper (top) side of the assembly, and the lower part of FIG. 1A corresponds to the lower (bottom) side of the assembly.

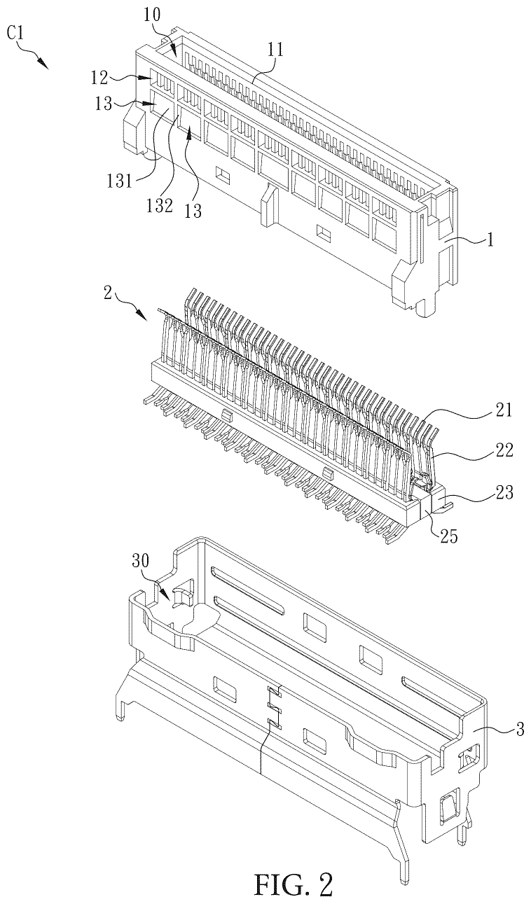

In one embodiment, as shown in FIG. 2, the receptacle connector C1 includes a receptacle insulating body 1, a plurality of receptacle terminal sets 2, and a receptacle shell 3, wherein a docking port 11 is provided on a top side of the receptacle insulating body 1, and a slot 10 extends inside the receptacle insulating body 1. The slot 10 is configured to receive the receptacle terminal set 2 so as to form a docking port 11 that may receive a portion of a mating connector with mating terminals. Furthermore, a mounting space 30 is disposed in the receptacle shell 3. The shell 3 may be formed of a metal sheet and may be connected to ground. The mounting space 30 is configured to receive the receptacle insulating body 1, thereby improving the structural protection for the receptacle insulating body 1 and effectively enhancing its anti-electromagnetic interference (EMI) capability to ensure the electromagnetic compatibility (EMC) of the receptacle connector C1 during high-speed signal transmission.

Continuing from the above, still referring to FIGS. 1A to 2, when the receptacle connector C1 and the plug connector C2 are plugged together, the docking port 11 of the receptacle insulating body 1 may adapt to the docking portion 5 of the plug connector C2, so that the docking portion 5 may extend into the docking port 11 and form an electrical connection with the receptacle terminal set 2. However, in other embodiments of the present application, certain structural features and components of the receptacle connector C1 may be adjusted as required in practice. For example, the receptacle terminal set 2 may be in the number of one or plural; or, the receptacle connector C1 may omit the receptacle shell 3, among other variations, to improve the design flexibility of the product.

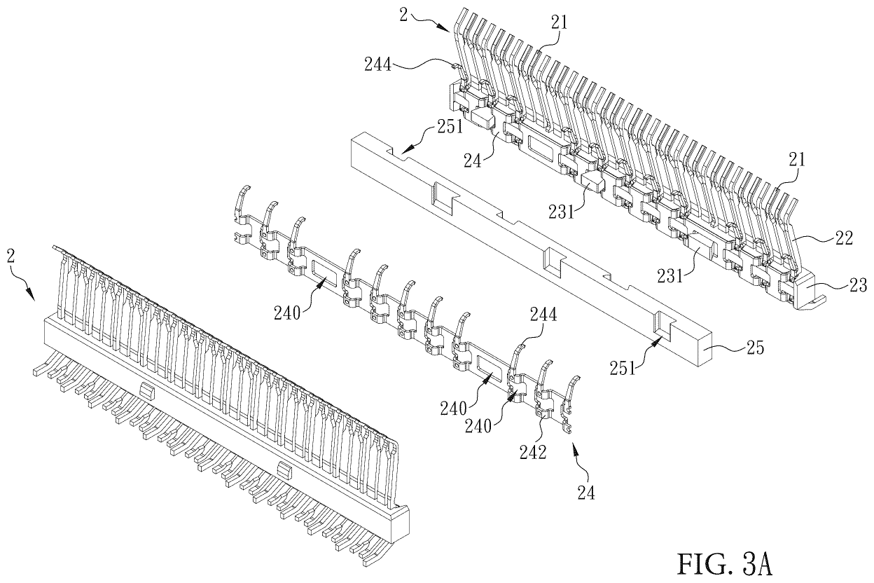

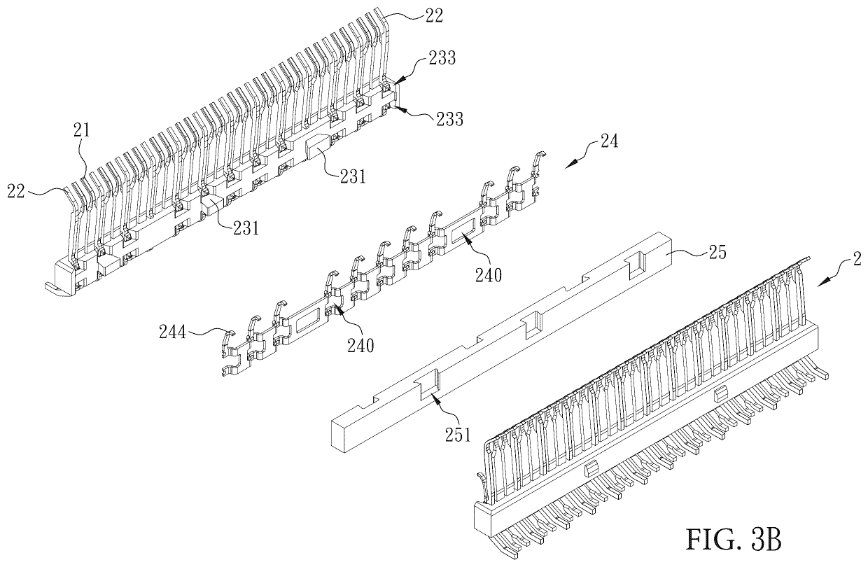

In the example illustrated, connector C1 has two terminal sets mounted on opposite sides of slot 10. FIGS. 3A to 3B show these terminal sets and components between them, with shell 3 and insulating body 1 hidden. The receptacle terminal set 2 includes a plurality of receptacle metal terminals. In the illustrated example, the terminal set includes two types of terminals, a first-type, which may be designated as signal terminals, and a second-type, which may be designated as ground terminals. In the embodiment, the receptacle metal terminals may be arranged along the horizontal axis (X-axis) direction, and their types may be divided into receptacle signal terminals 21 and receptacle ground terminals 22. The signal and ground terminals may be manufactured using different production processes, such as stamping the signal terminals from a sheet of metal in one operation and stamping the ground terminals from a sheet of metal in a different operation.

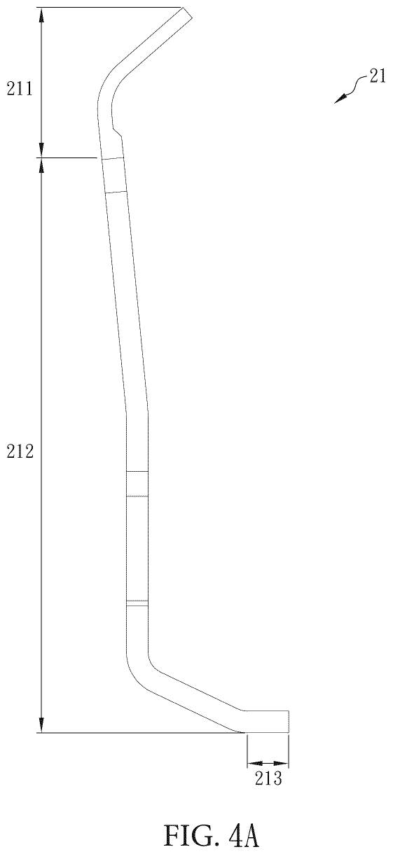

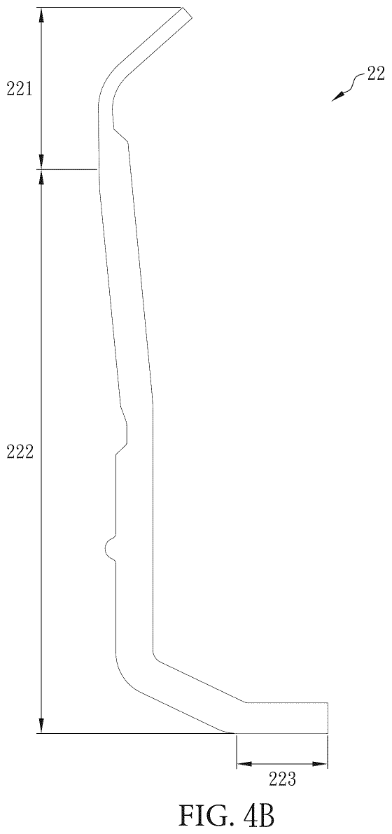

FIGS. 3A and 3B illustrate that the terminals of the terminal sets are disposed in respective rows extending in the horizontal direction. FIGS. 4A and 4B are side views, taken along the row of a signal terminal and a ground terminal, respectively. The receptacle signal terminals 21 may be formed by a forming process in which a metal sheet is first cut into elongate strips and then bent. Moreover, the receptacle signal terminals 21 are each divided into a signal contact section 211, a signal relay section 212, and a signal fixing section 213. The signal contact section 211 is configured to electrically connect to the plug signal terminal 61 of the plug connector C2. In this example, the signal contact sections are shaped as compliant beams with a contact surface on one side. The signal fixing section 213 is configured to be electrically coupled to the circuit board and may be pressed against or attached to the circuit board (e.g., via solder). The signal relay section 212 is located between the signal contact section 211 and the signal fixing section 213 and electrically connects those sections. In the example of a vertical connector, these sections are arranged from top to bottom along the vertical axis (Z axis).

The receptacle ground terminal 22 is formed by a blanking process in which a metal sheet is directly cut into desired shape, and the receptacle ground terminal 22 is divided into a ground contact section 221, a ground relay section 222 and a ground fixing section 223 from top to bottom along the vertical axis (Z axis). The ground contact section 221 is configured to electrically connect to the plug ground terminal 62 of the plug connector C2, the ground fixing section 223 is configured to be connected to the circuit board and may be pressed against or attached to the circuit board (e.g., via solder). The ground relay section 222 is located between the ground contact section 221 and the ground fixing section 223 and electrically connects those sections.

The side view of the ground terminal in FIG. 4B reveals a surface that was the surface of the metal sheet from which the ground terminal was stamped. This surface may be referred to as the broadside of the terminal. The dimensions of the ground terminal in this plane may be larger than the thickness of the sheet of metal from which the ground terminal is stamped. For example, as seen in FIG. 4B a protrusion extends from the terminal, providing a portion for the terminal with a larger dimension than the thickness of the metal. However, as the dimensions in this plane are set by a stamping die, portions of the terminal, such as the tip, may have smaller dimensions than the thickness of that sheet of metal. Alternatively or additionally, thinner portions, such as the tip, may be stamped and then reduced in thickness by coining or other metal working operations.

The side view in FIG. 4A of the signal terminal reveals the cut edge of the metal sheet from which the signal terminals of the row was stamped. The signal terminals may be stamped from the same sheet of metal as the ground terminals, or may be stamped from a separate sheet, which may have the same or different thickness than the sheet of metal from which the ground terminals were stamped. The dimensions of the signal terminal in this plane are not larger than the thickness of the sheet of metal from which the signal terminal is stamped. However, portions of the terminal, such as the tip, may have smaller dimensions than the thickness of that sheet of metal. Alternatively or additionally, thinner portions, such as the tip, may be stamped and then reduced in thickness by coining or other metal working operations.

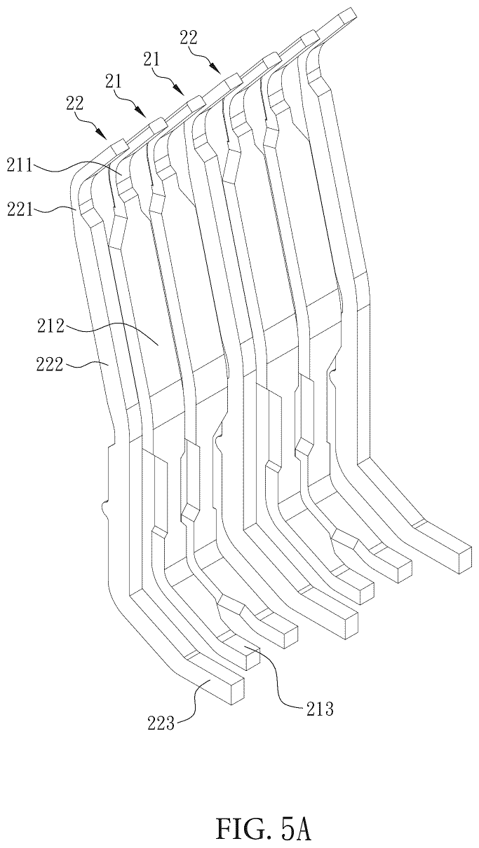

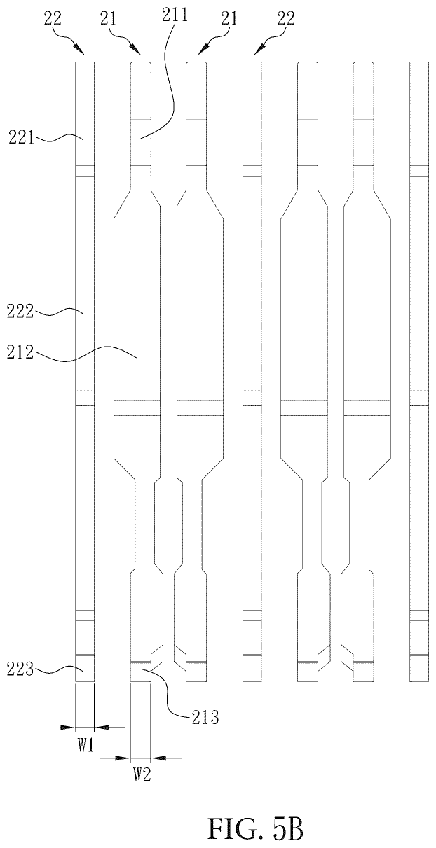

The signal terminals may have broadsides, which are not visible in FIG. 4A because they extend perpendicular to the plane illustrated. The broadsides of the signal terminals are illustrated in FIG. 5B, which illustrates the terminals from an orientation that is transverse (here orthogonal) to the orientation of FIGS. 4A and 4B.

FIGS. 5A and 5B show the arrangement of some receptacle signal terminals 21 and receptacle ground terminals 22. In this example, there are two adjacent receptacle signal terminals 21 between two receptacle ground terminals 22. When viewed from the side, the horizontal projection area (along the horizontal axis, i.e., the X-axis direction) of the receptacle ground terminals 22 will fully cover the receptacle signal terminals 21. In some examples, the horizontal projection area of the ground terminals may extend beyond the signal terminals in one or more directions at one or more locations along the signal terminals, such as in the fixing sections. In some embodiments, a useful level of improvement may be achieved as long as the horizontal projection area of the ground fixing section 223 of the receptacle ground terminal 22 may fully cover the signal fixing section 213 of the receptacle signal terminal 21. As such, for the signal transmission path between the receptacle signal terminal 21 and the circuit board, the receptacle ground terminal 22 (or at least the ground fixing section 223) may form a three-dimensional “encapsulating” environment, achieving an isolation and shielding effect. This encapsulating environment may reduce the electromagnetic coupling between the receptacle signal terminals 21 located on the opposite sides thereof and suppress crosstalk interference.

In the example illustrated, the end portion of the ground fixing section 223 of the receptacle ground terminal 22 is different from the end portion of the signal fixing section 213 of the receptacle signal terminal 21 on the longitudinal axis (Y axis). In some embodiments, the end portion of the ground fixing section 223 extends beyond the end portion of the signal fixing section 213 (as shown in FIG. 4A) to enhance the shielding effect of the receptacle ground terminal 22.

Further, referring to FIGS. 5A to 5B again, to reduce parasitic capacitance or unnecessary coupling between metal terminals, while still reserving more space for the receptacle signal terminal 21 within the predetermined design space or terminal spacing limit, at least 80% of the area of the receptacle ground terminal 22 itself has a horizontal width (along the horizontal axis, i.e., the X-axis direction) that is smaller than the horizontal width (along the horizontal axis, i.e., the X-axis direction) of the receptacle signal terminal 21. In some examples, the receptacle ground terminal 22 is narrower and thinner than the receptacle signal terminal 21 in a direction parallel to the row of terminals in the terminal set. Furthermore, the horizontal width W1 of the ground fixing section 223 of the receptacle ground terminal 22 may also be smaller than the horizontal width W2 of the signal fixing section 213 of the receptacle signal terminal 21. As such, for the overall design of the receptacle connector C1 (as shown in FIG. 2), the receptacle ground terminal 22 may occupy a smaller percentage of the space between adjacent terminals than the signals terminals, so that a sufficient space is available for the receptacle signal terminal 21 to have a width that provides a suitable impedance. Moreover, it may also reduce unnecessary parasitic coupling, greatly improving the flexibility of the layout and assembly efficiency of metal terminals.

In the example of FIGS. 5A and 5B, a pair of signal terminals has an average edge-to-edge spacing over the relay sections of the signal terminals of the pair that is less than an average edge-to-edge spacing over the fixing sections of the signal terminals of the pair.

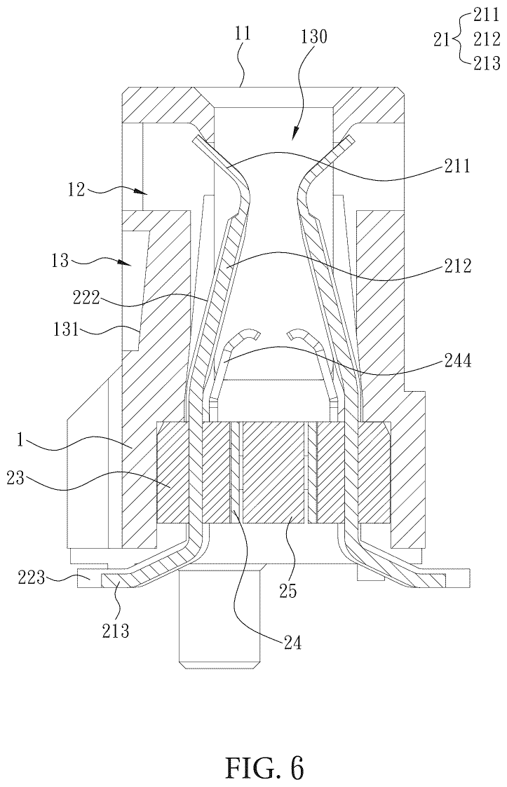

Referring to FIGS. 2 and 6, at least one groove 13 is disposed on one body sidewall (e.g., rear sidewall) of the receptacle insulating body 1. The groove 13 is concave from outside to inside, but not limited thereto. In the embodiment, the receptacle insulating body 1 is provided with a plurality of grooves 13, so that a supporting portion 132 may be formed between two adjacent grooves 13 to enhance the structural strength of the receptacle insulating body 1.

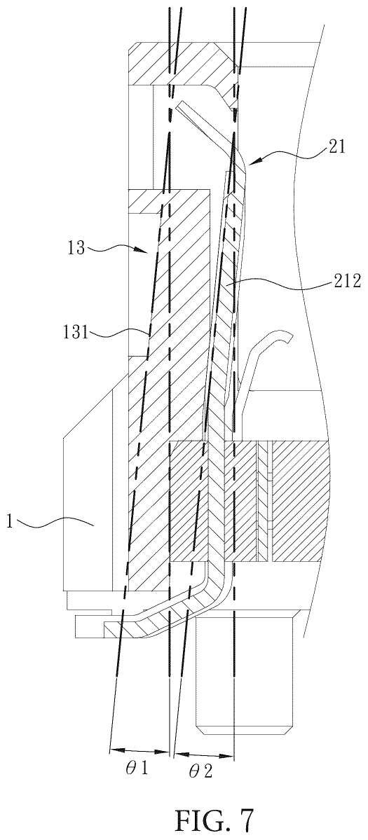

Furthermore, referring to FIG. 7, one of the groove walls 131 of the groove 13 is formed with an inclined surface, and the inclined surface maintains a first angle θ1 with respect to the vertical axis (Z axis). Furthermore, a horizontal projection area of the groove wall 131 extending along the longitudinal axis (Y-axis) direction may correspond to the signal relay section 212 and/or the ground relay section 222. When the receptacle connector C1 has not yet been mated with the plug connector C2, the receptacle signal terminal 21 and the receptacle ground terminal 22 remain in an unstressed state (as shown in FIG. 6), and the signal relay section 212 and the ground relay section 222 have an inclination angle which is different from the first angle θ1, and are further away from the inner wall of the receptacle insulating body 1.

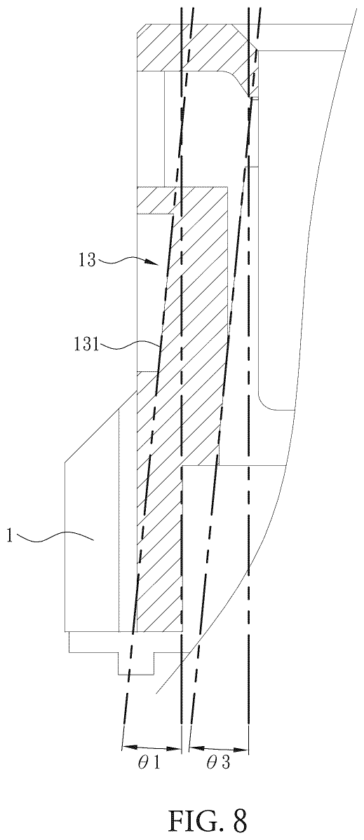

Continuing from the above, referring to FIGS. 1D and 7, when the receptacle connector C1 and the plug connector C2 are plugged together, the receptacle metal terminals (receptacle signal terminals 21, receptacle ground terminals 22) are affected by the plug metal terminals (plug signal terminals 61, plug ground terminals 62) and are deflected, so that the relay sections thereof (signal relay section 212, ground relay section 222) maintain a second angle θ2 with respect to the vertical axis (Z axis) respectively, and the second angle θ2 is substantially the same as the first angle θ1, thereby making the signal relay section 212 and the ground relay section 222 substantially parallel to the inclined surface. To ensure that the receptacle metal terminal remains substantially parallel to the inclined surface in the groove 13, in some embodiments, referring to FIGS. 1D and 8, a third angle θ3 may be maintained between the inner wall surface of the receptacle insulating body 1 and the vertical axis (Z axis), and the third angle θ3 is substantially the same as the second angle θ2 and the first angle θ1. As such, when the receptacle metal terminal is displaced by force, its relay portion (signal relay section 212, ground relay section 222) may stick to the inner wall surface of the receptacle insulating body 1, thereby making the relay portion maintain the second angle θ2 and remain substantially parallel to the inclined surface in the groove 13.

To summarize, still referring to FIG. 1D and FIG. 7, with the groove wall 131 of the groove 13 designed as an inclined surface, the spacing (thickness) between the receptacle metal terminal (receptacle signal terminal 21, receptacle ground terminal 22) and the receptacle insulating body 1 may be kept as consistent as possible after it is displaced by force. This facilitates maintaining a uniform electric field distribution around each of the receptacle metal terminals, avoiding uneven electromagnetic coupling caused by changes in the dielectric constant or thickness of certain areas, and effectively reducing crosstalk interference. Further, maintaining a consistent dielectric environment also facilitates keeping the characteristic impedance of the receptacle signal terminal 21 stable, thereby improving the stability of the overall electromagnetic environment; reducing signal reflections and distortion caused by impedance mismatch, thereby improving signal integrity and ensuring the reliability and performance of high-speed signal transmission.

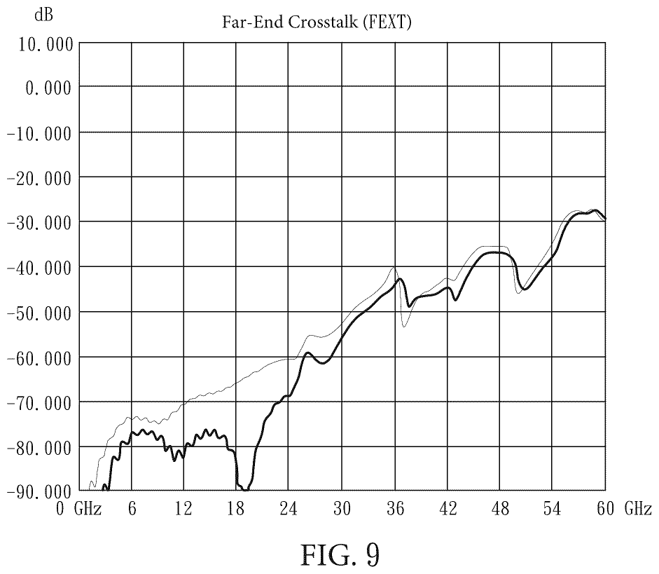

FIG. 9 shows simulated Far-End Crosstalk (FEXT) for a connector as pictured herein. The horizontal axis in the test view represents the frequency range, which is from 0 GHz to 60 GHz; the vertical axis in the test view represents the amplitude of FEXT, which is from −90 dB to 10 dB. In terms of the 32 GHz Far-End crosstalk test results, the test data is −60.75 dB (as shown by the thick line) when the groove 13 is formed with an inclined surface as provided by the present application, whereas the test data is −48.2 dB (as shown by the thin line) when the groove is formed with a vertical inner wall (non-inclined surface). It may be seen that the receptacle connector C1 with the groove 13 having an inclined surface may obviously suppress crosstalk more effectively and improve signal integrity.

Referring to FIGS. 2 and 6 again, a plurality of through holes 12 may be provided on the body sidewall of the receptacle insulating body 1. Each of the through holes 12 extends into the slot 10 and is located at a position above the groove 13. The number of the plurality of through holes 12 may be the same as the number of the plurality of receptacle metal terminals (but not limited thereto), and will correspond to the plurality of receptacle metal terminals in terms of the positions. When the receptacle connector C1 and the plug connector C2 are plugged together, the plurality of receptacle metal terminals are displaced by force, and then their top ends may respectively extend into the corresponding through holes 12. In some embodiments, each of the through holes 12 provides a movable space for the top area of the receptacle metal terminal, preventing the receptacle metal terminal from being affected by the inner wall of the receptacle insulating body 1 and unable to form its predetermined displacing angle (second angle θ2). Further, when the receptacle insulating body 1 is mounted in the receptacle shell 3, the housing sidewall of the receptacle shell 3 will cover each of the grooves 13 (as shown in FIGS. 1B and 6).

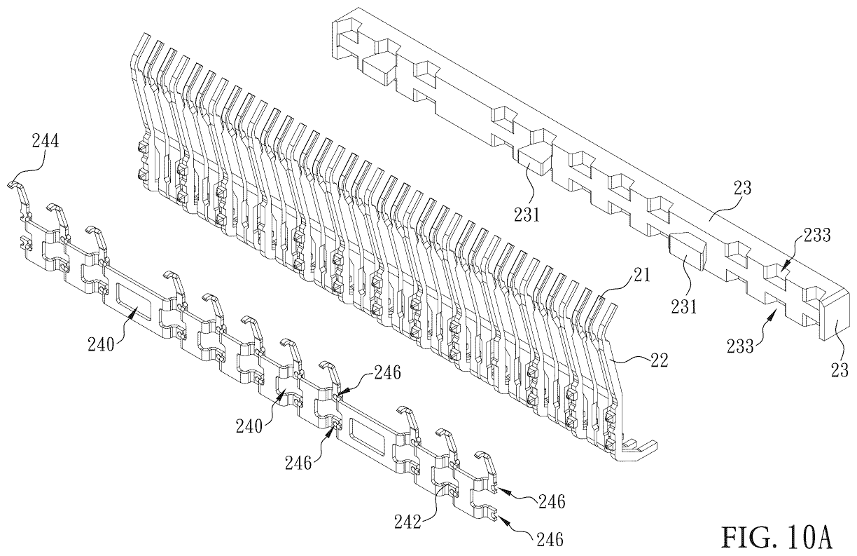

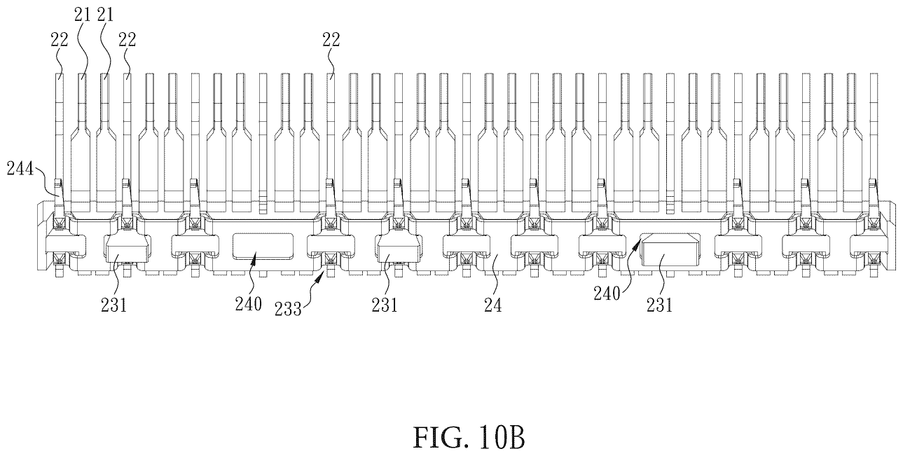

In addition, referring to FIGS. 2 to 3B and FIGS. 10A to 10B, to maintain the convenience of assembly, the receptacle terminal set 2 also includes a terminal set housing 23. The terminal set housing 23 may be insulative and may hold a part of the plurality of receptacle signal terminals 21 and the receptacle ground terminals 22. The housing, for example, may directly or indirectly, encapsulate portions of the signal and/or ground terminals. The terminal set housing 23 encapsulates portions of the relay sections in the illustrated example. The housing may be formed using an injection molding process. FIG. 10A shows the housing exploded from the terminals and is simplified for ease of illustration, as FIG. 10A does not specifically show in housing 23 the space occupied by the receptacle signal terminals 21 and the receptacle ground terminals 22. However, it is understood by those with common knowledge in the art that the structure and arrangement modes of the terminal set housing 23, the receptacle signal terminal 21 and the receptacle ground terminal 22 are based on the technical features of injection molding.

Further, referring to FIGS. 10A to 10B, the receptacle connector C1 is provided with two receptacle terminal sets 2 (as illustrated in the example of FIG. 2). The terminal sets 2 are inserted into receptacle insulating body 1 with contact sections exposed in slot 10 to form a docking port 11 for mating with a docking portion 5 of a plug connector.

In order to effectively control the position and distance between each of the receptacle terminal sets 2, the receptacle connector C1 may also be provided with a support member 25. The support member 25 is configured to be between and connected to the two terminal set housings 23 to form a terminal assembly. In this way, the distance between each of the receptacle terminal sets 2 may be effectively adjusted by changing the thickness of the support member 25. However, in some embodiments, the support member 25 may be joined with only one of the receptacle terminal sets 2 to adjust the position of the receptacle terminal set 2 in the receptacle insulating body 1. In some embodiments, the plurality of receptacle metal terminals may be assembled on the support member 25, which is equivalent to using the support member 25 as a terminal set housing 23. Alternatively or additionally, the terminal set housings may be directly joined to each other without an intervening support member.

Continuing from the above, referring to FIGS. 2 to 11B again, a plurality of projections 231 are provided on one side of the terminal set housing 23. The projections may be shaped to provide a reliable engagement, including, for example, having wider and narrower portions, with at least one wider portion more distal than a narrower portion. With such a configuration, when the projection is slid into a channel with a complementary shape, narrower portions of the channel will interfere with wider portions of the projection to block the projection from being withdrawn from the channel. In this way, the terminal set housing 23 may be simply, but securely held to another component of the connector containing the channels, such as support member 25.

In the illustrated example, the projection 231 has a gradually varying cross-sectional shape, increasing in width towards its distal end. In this example, the other component of the connector to which the terminal set housing 23 is to be secured is support member 25, which is provided with a plurality of channels 251 on one side opposite to the terminal set housing 23, and the cross-sectional shape of each of the channels 251 matches the projection 231. Therefore, the channel 251 and the projection 231 may be embedded in each other, and the wedge shape feature causes friction locking on the contact surfaces of the two, so that the support member 25 and the terminal set housing 23 are stably fixed. Specifically, the projection 231 is configured as a wedge-shaped protrusion. In the embodiment, the horizontal cross-sectional shape of the wedge-shaped protrusion is trapezoidal, and its width gradually widens outward from the terminal set housing 23. The channel 251 is configured as a wedge-shaped groove, and the configuration of the wedge-shaped groove is essentially the same as that of the wedge-shaped protrusion, and the width of its horizontal cross-sectional shape gradually narrows outward from the support member 25, but not limited thereto.

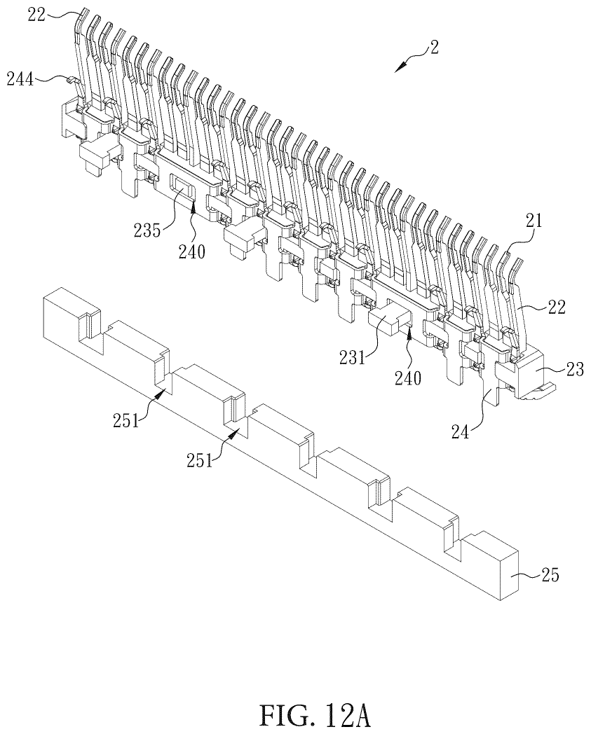

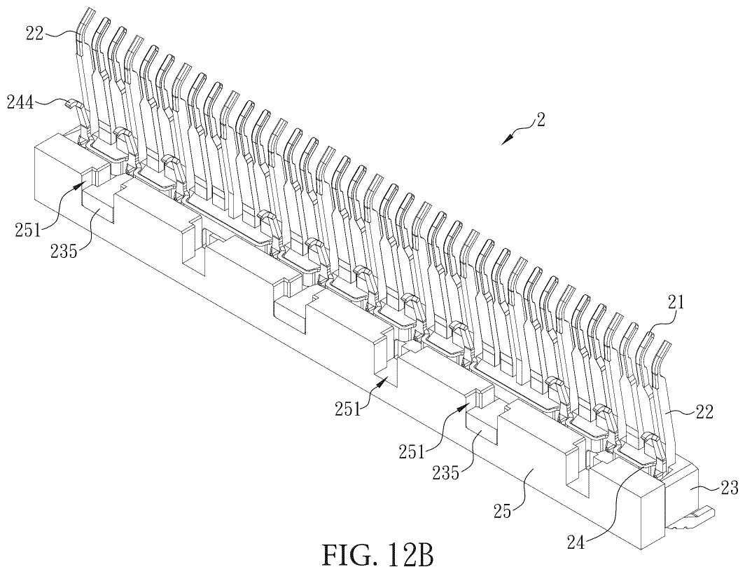

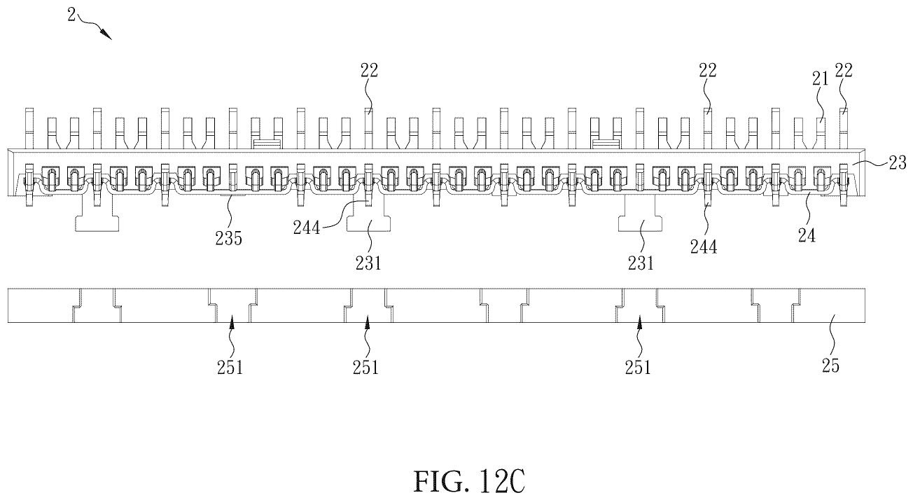

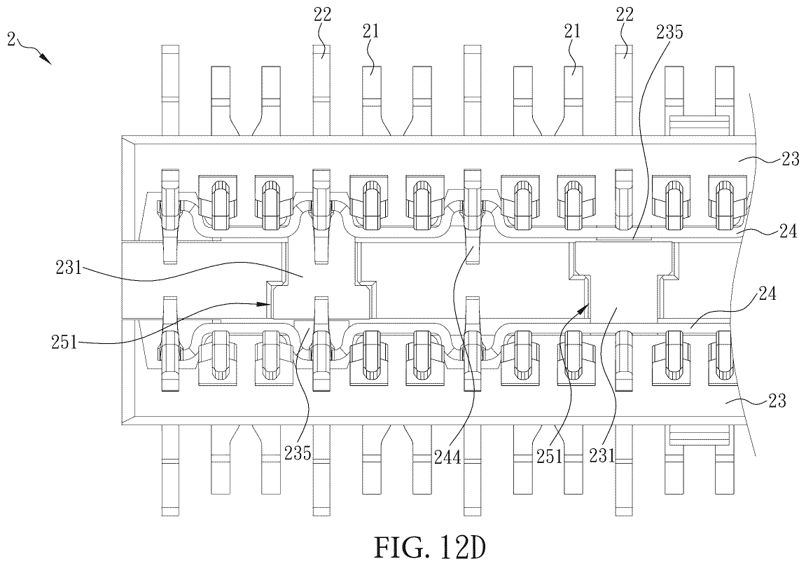

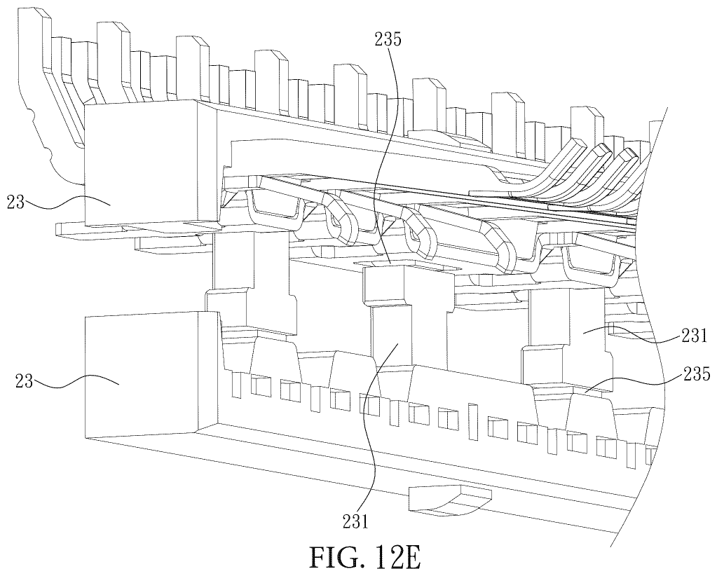

In another embodiment of the present application, referring to FIGS. 12A to 12E, the projection 231 provided on the terminal set housing 23 has a cross-sectional shape with varying dimensions with at least one wider portion more distal than a narrower portion. In the illustrated example, a protrusion has a T-shaped cross-sectional shape. The channel 251 of the support member 25 is a groove with a T-shaped cross section, and the groove may penetrate two opposite side surfaces (front and rear sides) of the support member 25.

Furthermore, the two terminal set housings 23 are respectively provided with at least one limiting block 235, which in this example corresponds to a channel 251 into which projection 231 from a different component of the connector may extend. In the example illustrated, the limiting block 235 provided on one of the terminal set housings 23 aligns with a projection 231 from another terminal set housing 23, which will also be attached to support member 25. When the plurality of terminal set housings 23 are respectively assembled to the front or rear side of the support member 25, each of the projections 231 can be slid into a corresponding channel 251 in a top to bottom. When inserted into the corresponding channel, each of the projections 231 will abut against the limiting block 235 of the other terminal set housing 23 (as shown in FIG. 12E). Such a configuration may enhance the stability of the attachment between the plurality of terminal set housings 23 and the support member 25 when assembled together. The configurations of the projections 231 and the channels 251 are not limited to the horizontal cross-sectional shape described above. In other embodiments, the configurations of the projection 231 and the channel 251 may be interchanged with each other such that a projection from another component of the connector may extend into a channel of the terminal set housing; or, the shapes of the features, such as the projections and the channels, on the components of the connector to be joined may not be exactly the same, but may nonetheless sufficiently secure the components to each other if the feature of one component embeds into or otherwise engages with the other component to hold the components together. Further, it is not a requirement that the projections extend from the terminal set housing into channels in another component. In other examples, the projections may extend from the other component into channels in the terminal set housing. In those examples, the projections and channels may nonetheless interlock to hold the terminal set to another component (such as a support member 25 or another terminal set). In some embodiments, however, the projection 231 and the channel 251 match each other and both have a cross-sectional shape with varying dimensions along the their lengths, such that the geometric structure formed by the cross-sectional shapes, are complimentary and the projection 231 and the channel 251 engage and interlock, thereby enabling secure locking.

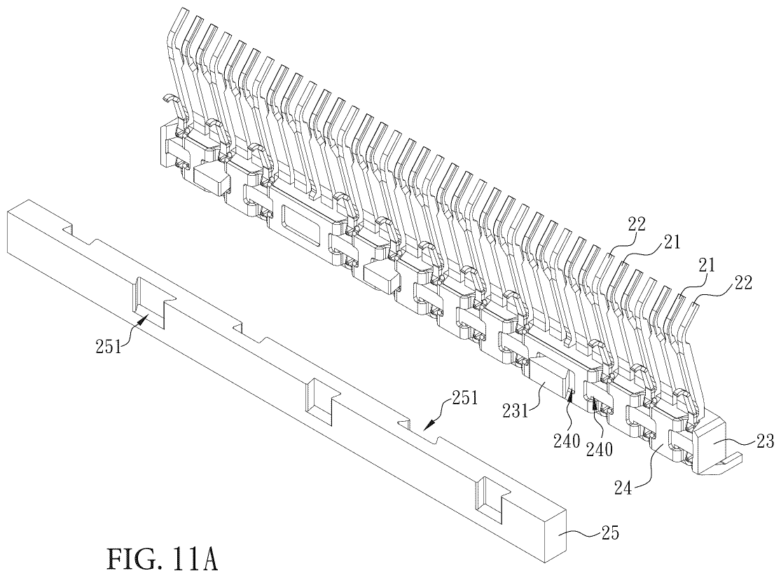

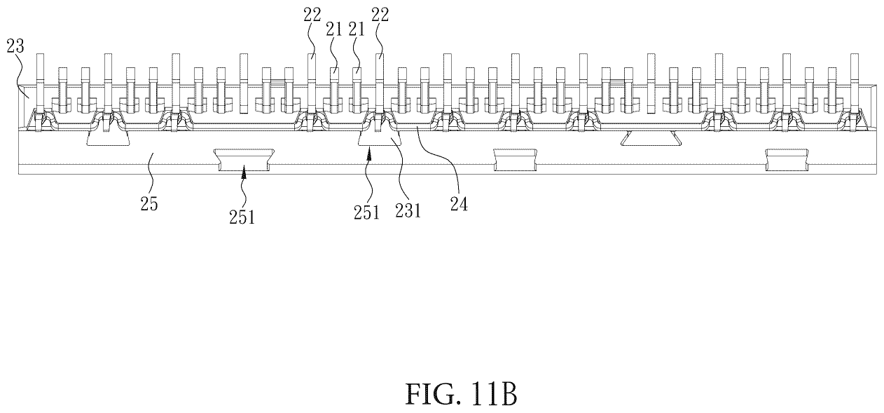

Optionally, in order to maintain a good electromagnetic environment and prevent external noise from coupling to internal signals, referring to FIGS. 2 and 11A to 11B, the receptacle terminal set 2 may be combined with a metal shield 24 as part of forming a terminal assembly. The shield may include openings that impact its electromagnetic performance and/or facilitate attachment. In some examples, the openings may be aligned with some or all of the ground terminals in a terminal set. In some examples, the openings enable projections, such as projections 231 and/or limiting block 235, to pass therethrough. Accordingly, both the openings in the shield and the projections may be aligned with some or all of the ground terminals of the terminal set. With projections extending into or through the openings in the shield, when the terminal set is fixed to another component, including as described above, the shield may be locked in place relative to at least the terminal set 2.

The metal shield 24 may be in the shape of an elongated strip and has a plurality of openings 240 provided thereon. Such a shield, for example, may be stamped from a sheet of metal, which may be bent or otherwise worked to incorporate features, such as projections that contact ground terminals or compliant arms that contact other ground structures within the receptacle connector or a mating plug connector. Some or all of the openings 240 may be sized and positioned to allow a corresponding wedge-shaped protrusion to pass through, such that the protrusion may be smoothly assembled to the channel 251. However, in other embodiments of the present application, the terminal set housing 23 may be provided with protrusions of different shapes and structures according to different designs or actual needs, and is not limited to wedge-shaped protrusions. In some embodiments, the opening 240 provided in the metal shield 24 has a geometric structure for adapting to the engagement protrusion (including but not limited to the wedge-shaped protrusion) on the terminal set housing 23. The opening 240 provided in the metal shield 24 may have a geometric structure for adapting to the channel 251 (such as the protrusion-type channel 251) of the support member 25, so as to allow the aforementioned protrusion to pass through.

Continuing from the above, referring to the example of FIGS. 2 and 11A to 11B, t the openings 240 are substantially aligned with the receptacle ground terminals 22, and the wall area of the shield between two adjacent openings 240 is substantially aligned with the gap between two adjacent receptacle signal terminals 21. For example, the centerline of each such wall area may be aligned, in the row direction, a centerline between two adjacent signal terminals. Since the position of the metal shield 24 is closer to the receptacle metal terminal and may correspond to the gap between adjacent receptacle signal terminals 21, it may block part of the electromagnetic coupling between the adjacent receptacle signal terminals 21. Further, the metal shield 24 may be located between the two receptacle terminal sets 2 to further provide a shielding effect, so that opposite receptacle signal terminals 21 in the two receptacle terminal sets 2 are shielded from each other by the metal shield 24 to improve shielding efficiency. It is worth mentioning here that the aforementioned “alignment” refers to relative positions between two structural features (such as the opening 240 and the receptacle ground terminal 22, the sidewall area and the gap, etc.), and is not limited to direct alignment, but also includes displacement or lateral correspondence within a certain tolerance range. If that tolerance is small enough to achieve the aforementioned shielding or isolation effect, is the components may be considered to be in an aligned state.

Please refer to FIGS. 2 and 11A to 11B again. In order to enhance the assembly stability between the terminal set housing 23 and the metal shield 24, a plurality of recesses 233 are provided on one side of the terminal set housing 23. The metal shield 24 is provided with a plurality of projections 242, each of the projections 242 may extend into the corresponding recess 233, and at least some of the projections 242 are aligned with an opening 240 along the vertical axis (Z axis) direction. Thus, by means of the projection 242 and the recess 233, the metal shield 24 may be easily mounted to the terminal set housing 23 without being easily displaced from the expected mounting position. In the illustrated embodiment, the metal shield 24 is bent and deformed to form each of the projections 242, but manufacturing of the metal shield is not limited thereto. The projections 242 may give the shield a wavy or corrugated shape. Further, the engagement protrusions of the terminal set housing 23 (such as the projection 231), the opening 240 of the metal shield 24, and the recess 233 etc., each may have a position that corresponds to the receptacle ground terminal 22 to reduce the impact on the dielectric environment where the receptacle signal terminal 21 is located (such as changes in the thickness of the dielectric layer).

In some examples, the shield may be coupled to the ground terminals of the terminal set. That coupling may be enhanced by the recesses 233 and/or the projections 242. In some examples, a portion of the ground terminal (which may include a projection-such as a bump as illustrated in FIG. 4B) may extend into the recess 233. When a shield is held against the terminal set housing, the projections 242 may press against portions of the ground terminals within the recesses 233 and/or a projection from the ground terminal may pass through the shield. The shield may be held against the terminal set housing using techniques as describe above. For example, the shield may be captured between the terminal set housing and another connector component such as support member 25. Such an arrangement facilitates simple, yet stable, construction of the connector. The shield for a terminal set housing may be placed next to the housing with projections from one or both of the terminal set housing and other component extending into or through the openings of the shield. Those projections may be slid into channels in the terminal set housing or other component, capturing the shield between the terminal set housing and other component.

In addition, referring to FIGS. 2 and 10A to 11B, the metal shield 24 may also provided with a plurality of elastic arms 244, each of which may be positioned to contact the receptacle ground terminal 22 to enhance the grounding and shielding effect of the metal shield 24 in the application. The contact may occur in a mated state of the receptacle connector or when a mating connector is inserted into the receptacle connector and the elastic arms are deflected.

Alternatively or additionally, the elastic arms may contact a ground structure in a mating connector mated with the receptacle connector. In the illustrated embodiment, the openings 240 are arranged along the vertical axis (Z-axis) on the elastic arms 244 to prevent the receptacle signal terminal 21 from being accidentally touched. Further, the metal shield 24 may be provided with at least one aperture 246, which corresponds to the receptacle ground terminal 22 and is configured to be injected with liquid solder. Once the solder hardens, the solder, the metal shield 24 and the receptacle ground terminal 22 will be electrically connected. Moreover, this may also ensure that the metal shield 24 and the receptacle ground terminal 22 are tightly jointed to maintain good electrical performance, but not limited thereto.

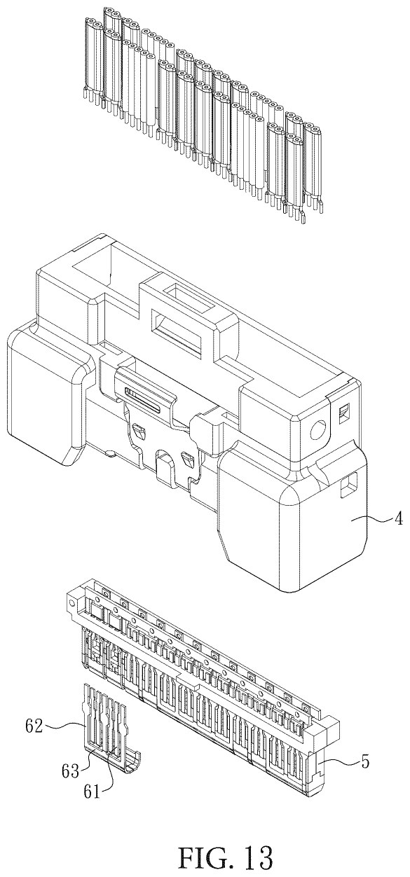

Referring to FIGS. 1A to 1D and 13, the plug connector C2 includes a plug insulating body 4, a docking portion 5 and a plug terminal set 6, wherein the docking portion 5 is plate-shaped and fixed to the plug insulating body 4 along the vertical axis (Z axis) direction.

According to actual needs, the docking portion 5 may be integrally formed with the plug insulating body 4, or may be a separate component and assembled to the plug insulating body 4. Furthermore, the configuration of the docking portion 5 is adapted to the docking port 11 of the receptacle connector C1, and thus, it may extend into the slot 10 of the receptacle connector C1 through the docking port 11.

Continuing from the above, referring to FIG. 13, the plug terminal set 6 includes a plurality of plug metal terminals, and the plurality of plug metal terminals are supported by the docking portion 5. The plug metal terminals may be of two or more types, including plug signal terminals 61 and plug ground terminals 62.

Docking portion 5 is shaped for insertion into a mating connector, such as connector C1 described above. In the example illustrated, the docking portion 5 is plate-like and has two opposing planar surfaces at which contact sections of terminals are exposed. The opposing surfaces are joined by a bottom (in the orientation shown in FIG. 1D), which joins the opposing surfaces along edges. Docking portion 5 may be formed from one or more insulative components, formed by molding or other suitable operation.

The plug metal terminals may be disposed on the docking portion, for example, by inserting portions of the terminals into channels in the insulative portions. Alternatively or additionally, some or all of the plug metal terminals may be disposed on the docking portion by molding the insulative portions around portions of the terminals. Regardless of how disposed on the docking portions, contact sections of the plug metal terminals may be exposed on a surface of the docking portion for mating with terminals in a mating connector, such as is illustrated, for example, in FIG. 1A.

In the illustrated embodiment, the plug connector C2 has two plug terminal sets 6, one of the plug terminal sets 6 being arranged on the front side of the docking portion 5, and the other of the plug terminal sets 6 being arranged on the rear side of the docking portion 5, wherein the plug signal terminals 61 and the plug ground terminals 62 in the same plug terminal set 6 are arranged along the horizontal axis (X-axis). Since the arrangement and configuration of the two plug terminal sets 6 are substantially the same or similar and the difference is only in that they are disposed on different sides of the docking portion 5, only one plug terminal set 6 will be described below. It should be appreciated, however, that more than one plug terminal set may be supported on the same side of the docking portion and/or the plug terminal sets may have more or fewer signal terminals than illustrated. In some examples, a plug terminal set 6 may provide terminals in each of multiple high-speed portions of the connector.

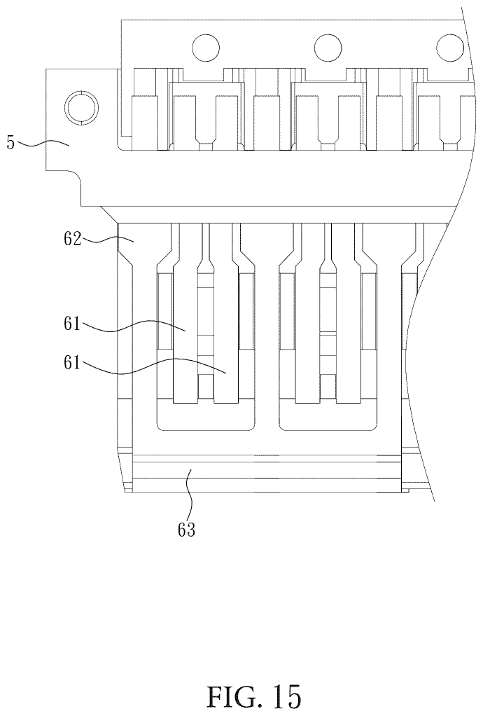

Furthermore, referring to FIGS. 13 to 15, at least one plug signal terminal 61 (two plug signal terminals 61 in the illustrated embodiment) is provided between at least two of the plug ground terminals 62 in the plug terminal set 6. In the example illustrated, pairs of plug signal terminals are disposed between two of the plug ground terminals. The bottoms of the plug ground terminals 62 of the plug terminal set 6 may be integrally connected along the horizontal axis (X-axis) by an elongated member, elongated along the horizontal axis, that forms a grounding zone 63. The grounding zone 63 may extend to cover a portion of the front side surface of the docking portion 5. As illustrated, that portion of the front surface is adjacent the edge at which the front surface joins the bottom. The grounding zone may bend and extend to the bottom surface of the docking portion 5. The grounding zone may bend over the edge and may cover at least a portion of the bottom. The grounding zone, for example, may cover at least one-third of the bottom surface of the docking portion 5.

The horizontal width of the grounding zone 63 may be greater than the horizontal width of any one of the plug signal terminals 61. In other embodiments of the present application, the grounding zone 63 may only cover the bottom surface of the docking portion 5.

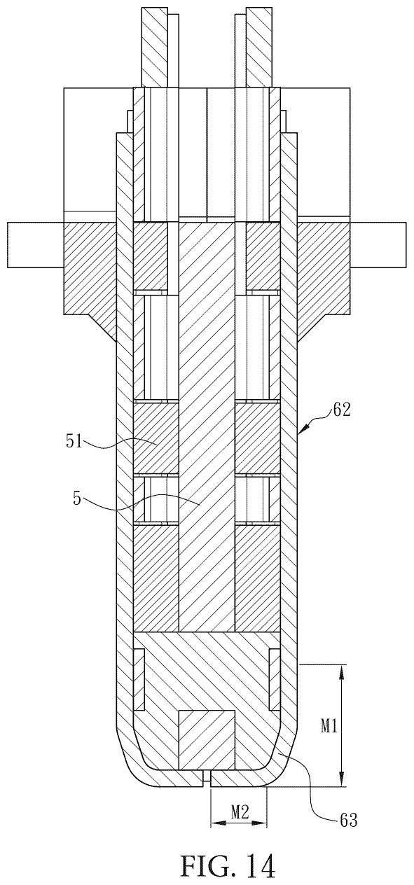

Referring to FIGS. 13 to 15 again, the bottoms of the plurality of plug ground terminals 62 may be integrally connected to form a plurality of grounding zones 63, but not limited thereto. In some embodiments of the present application, the bottoms of all plug ground terminals 62 are integrally connected to form one single grounding zone 63. Further, the length M1 of the grounding zone 63 located on the front side of the docking portion 5 (the extension length along the vertical axis (Z axis) direction) may be greater than or equal to the length M2 of the grounding zone 63 located on the bottom surface of the docking portion 5 (the extension length along the longitudinal axis (Y axis) direction), so as to overall form a significantly wide area. Further, the plug ground terminals 62 of the two plug terminal sets 6 located on different sides of the docking portion 5 extend to the grounding zone 63 on the bottom surface of the docking portion 5 respectively and are not mechanically connected with each other in the illustrated embodiment. In some examples, the grounding zones extending from different sides of the docking portion 5 also are not electrically connected within the docking portion. As shown for example in FIG. 14, edges of the grounding zones may face each other on the bottom of the docking portion 5, but are separated by a gap. In this way, due to the larger width and area of the grounding zone 63 and its structural design extending to the bottom surface, the plug ground terminal 62 and the grounding zone 63 together constitute an encapsulated shielding structure to form an effective electromagnetic shielding around the adjacent plug signal terminals 61, thereby reducing external interference to the plug signal terminal 61 and suppressing the crosstalk effect during signal transmission. Further, the extended configuration of the grounding zone 63 facilitates a contact with the elastic arm 244 of the receptacle connector C1 to ensure a stable grounding connection between the two, further optimizing electromagnetic compatibility (EMC) and improving signal integrity.

In order to enhance the shielding effect between the two plug terminal sets 6, referring to FIGS. 13 to 15, at least one metal barrier sheet 51 is provided in the docking portion 5, and the metal barrier sheet 51 is in direct contact with at least part of the plug ground terminals 62 (but not limited thereto), thereby forming an effective shielding barrier to reduce electromagnetic coupling between adjacent plug signal terminals 61, thereby facilitating reducing crosstalk interference and improving signal integrity. Further, the metal barrier sheet 51 is provided to not only be able to directly contact the plug ground terminal 62, but also to form a connection with the metal shield 24 in the receptacle connector C1, further improving the electromagnetic compatibility (EMC) of the overall system and ensuring effective grounding and electromagnetic shielding, which is crucial for the stable transmission of high-speed signals, and further improving the ability of the connector set C to resist external interference.

The above description is only a preferred feasible embodiment of the present application and does not limit the scope of the claims of the present application. The above description is by way of example to make the objects, technical solutions and advantages of the present application clear. Those skilled in the art can understand the advantages and effects of the present application from the contents disclosed in this specification. The present application may be implemented or applied through other different embodiments, and the details in this specification may also be modified and changed based on different viewpoints and applications without departing from the concept of the present application.

For example, the techniques described herein were illustrated in connection with a vertical board mount connector configured to mate with a plug terminating cables. The same techniques might be applied to a right angle connector or a connector that mates with a connector attached directly to a solid state drive or other component of a computer system.

Although this document may provide examples of parameters containing specific values, it should be understood that the parameters do not need to be exactly equal to the corresponding values, but can be approximated to the corresponding values within an acceptable error tolerance or design constraint. Further, unless the context clearly indicates or defines otherwise, the meanings of “a”, “an”, and “the” in the present application comprise plural forms.

It should be understood that although the wordings first, second, etc. may be used herein to describe various assemblies or signals, each of the assemblies or signals should not be limited by the above wordings. The above wordings are mainly intended to distinguish one assembly from another or one signal from another. Furthermore, the directional terms mentioned in the subsequent embodiments, such as “upper”, “lower”, “front”, “back”, “left”, “right”, etc., are only intended to refer to the directions in the drawings. Therefore, the directional terms used are intended to illustrate rather than limit the scope of the present application. In addition, the term “or” used herein may, depending on the actual circumstances, include any one or a combination of the associated listed items.

Furthermore, wordings such as “substantially” or “approximately” as used herein may refer to a numerical value or an average value of multiple numerical values within a deviation range of a specific value that can be recognized or determined by those skilled in the art, including certain specific errors that may arise when measuring the specific value due to limitations of the measurement system or device. For example, the numerical value referred to the wording substantially may comprise +5%, +3%, ±1%, ±0.5%, ±0.1% or one or more standard deviation ranges of the specific value.

It is specifically noted here that the structures of some assemblies in the present application may be the same or similar, and may differ only in their configuration positions. For example, two receptacle terminal sets are located on the front and rear sides of the support member, respectively, but they do not differ substantially in structure or function. Based on this, in the claims, for the sake of clear distinction and convenience of recitation, such assemblies with the same or similar structures are referred to with the wording “first” or “second”, for example, a first metal terminal, a second metal terminal, a first channel, a second channel, etc. Further, if the assembly is applicable to either a plug connector or a receptacle connector, the term “plug” or “receptacle” may not be used in the claim. Therefore, unless otherwise specified, the “two receptacle terminal sets” referred to in this specification correspond to and comprise the “first terminal set”, “second terminal set”, etc. described in the claims. By the same token, if there are other assemblies used in pairs, they can also be distinguished by the wording “first” and “second”. The reason why this specification does not intentionally and forcibly mark “first terminal set” and “second terminal set” in text and drawings is only to make the description more concise and does not affect the technical content or patent scope of the present application. In the subsequent description, if unified assembly numbers are used (such as terminal set housing 23, metal shield 24, etc.), they can also correspond to the above-mentioned “first”, “second” assemblies or the like according to actual needs.

Therefore, any equivalent changes envisaged by those skilled in the art without inventive labor based on the technical content disclosed in the present application should be included in the scope of the claims of the present application.

What is claimed is:

1. A shield for an electrical connector, the shield comprising:
an elongated metal strip bent to form a plurality of projections, wherein:
the metal strip comprises a plurality of openings, therethrough; and
the openings are aligned with the projections.

2. The shield of claim 1, wherein:
the metal strip is elongated in a first direction; and
the shield comprises a plurality of elastic arms each aligned with an opening of the plurality of openings along a second direction orthogonal to the first direction.

3. The shield of claim 1 in combination with a terminal set comprising a row of terminals and an insulative housing holding the terminals, wherein the insulative housing comprises a plurality of projections extending through respective openings of the plurality of openings.

4. The shield in the combination of claim 3, wherein:
the row of terminals comprise signal terminals and ground terminals; and
the plurality of openings are aligned with respective ground terminals in the terminal set.

5. The shield in the combination of claim 4, wherein an area of the metal strip between two adjacent openings is aligned with a gap between two adjacent signal terminals.

6. The shield in the combination of claim 3, wherein:
the insulative housing comprises a plurality of recesses; and
the plurality of projections of the elongated metal strip extend into respective recesses in the insulative housing.

7. A terminal assembly for an electrical connector, the terminal assembly comprising:
a terminal set comprising:
a plurality of signal terminals;
a plurality of ground terminals; and
a terminal set housing holding the plurality of signal terminals and the plurality of ground terminals; and
a metal shield which is assembled to a side of the terminal set housing and comprises a plurality of openings;
wherein:
the side of the terminal set housing comprises a plurality of protrusions, at least one of the plurality of protrusions aligned with a ground terminal of the plurality of ground terminals; and
the at least one of the plurality of protrusions extends through at least one of the plurality of openings.

8. The terminal assembly of claim 7, wherein:
at least two signal terminals of the plurality of signal terminals are adjacent to each other, and
an area of the metal shield between two adjacent openings is aligned with a gap between the two adjacent signal terminals.

9. The terminal assembly of claim 7, wherein:
the side of the terminal set housing is provided with a plurality of recesses,
each of the plurality of recesses is aligned with a respective ground terminal of the plurality of ground terminals;
the metal shield comprises a plurality of projections;
each of the plurality of projections of the metal shield extends into a respective recess of the plurality of recesses; and
openings of the plurality of openings extend through the metal shield at respective projections of the plurality of projections.

10. The terminal assembly of claim 7, wherein:
the metal shield is elongated in a first direction;
the metal shield comprises a plurality of elastic arms, and
each of the plurality of elastic arms is aligned with the plurality of openings along a second direction, orthogonal to the first direction.

11. The terminal assembly of claim 7, wherein:
the metal shield comprises at least one aperture aligned with a ground terminal of the plurality of ground terminals; and
the metal terminal is configured such that liquid solder is injected through the aperture, once the liquid solder hardens, the hardened solder, the metal shield and the ground terminal are electrically connected.

12. The terminal assembly of claim 11 in combination with an insulating body comprising a slot, wherein:
the plurality of signal terminals and the plurality of ground terminals comprise contact sections; and
the terminal assembly is disposed within the insulating body such that the contact sections of the plurality of signal terminals and the plurality of ground terminals are exposed in the slot so as to provide a docking port.

13. A connector comprising:
a terminal assembly comprising:
a terminal set comprising:
a plurality of metal terminals; and
a terminal set housing attached to the plurality of metal terminals, with a side of the terminal set housing comprising with a plurality of projections, each of which has a cross-sectional shape with varying dimensions; and
a support member, comprising a first side with a plurality of channels therein,
wherein:
the plurality of projections extend into respective channels of the plurality of channels; and
the cross-sectional shape of each of the plurality of channels matches the cross-sectional shape each of the projections, such that each of the channels and each of the projections mutually engage and interlock, whereby the terminal set housing is attached to the support member.

14. The connector of claim 13, wherein:
the plurality of projections are each configured as a wedge, and
the plurality of channels is each configured as a groove with tapered sides.

15. The connector of claim 13, wherein:
the terminal assembly further comprises a metal shield comprising a plurality of openings; and
the plurality of projections of the terminal set housing pass through respective ones of the plurality of openings such that the metal shield is captured between the terminal set housing and the support member.

16. The connector of claim 13, wherein:
the terminal set is a first terminal set and the plurality of channels are a first plurality of channels;
the terminal assembly comprises a second terminal set comprising a terminal set housing with a plurality of projections;
the support member comprises a second side with a second plurality of channels therein; and
the plurality of projections of the terminal set housing of the second terminal set extend into and interlock with respective channels of the second plurality of channels.

17. The connector of claim 16, wherein:
the terminal set housing of the first terminal set comprises at least one first limiting block aligned with a channel of the second plurality of channels; and
the terminal set housing of the second terminal set comprises at least one second limiting block aligned with a channel of the first plurality of channels.

18. The connector of claim 17, wherein:
the first limiting block buts against a projection of the terminal set housing of the second terminal set; and
the second limiting block buts against a projection of the terminal set housing of the first terminal set.

19. The connector of claim 18, wherein:
the terminal assembly further comprises a first metal shield and a second metal shield, wherein the first metal shield is assembled between the first terminal set housing and the support member, and the second metal shield is assembled between the second terminal set housing and the support member;
the first metal shield comprises a plurality of openings and a projection of the plurality of projections of the first terminal set housing or the first limiting block passes therethrough; and
the second metal shield comprises a plurality of openings and a projection of the plurality of projections of the second terminal set housing or the second limiting block passes therethrough.

20. The connector of claim 19, comprising an insulating body, wherein the terminal assembly is disposed within the insulating body.
